(19) United States
(12) Patent Application Publication
(10) Pub. No.: US 2008/0052709 A1
(43) Pub. Date: Feb. 28, 2008

(54) METHOD AND SYSTEM FOR PROTECTING HARD DISK DATA IN VIRTUAL CONTEXT

(75) Inventor: Liang Tang, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: Lenovo (Beijing) Limited, Beijing (CN)

(21) Appl. No.: 11/843,286

(22) Filed: Aug. 22, 2007

(30) Foreign Application Priority Data
Aug. 23, 2006 (CN) 200610115074.5

(51) Int. Cl. G06F 9/455

(52) U.S. Cl. 718/1; 711/E12.103

(57) ABSTRACT

The present invention discloses a method for protecting hard disk data in a virtual context, which comprises: a virtual machine monitor acquires information on a hard disk storage unit needed to be protected as instructed by a user; the virtual machine monitor acquires information on a hard disk storage unit to be accessed by a hard disk read-write command from operating system based on the read-write command; the virtual machine monitor judges whether the hard disk storage unit to be accessed by the read-write command is the hard disk storage unit needed to be protected based on the information on the hard disk storage unit to be accessed by the read-write command as well as the information on the hard disk storage unit needed to be protected as instructed by the user; and the hard disk read-write command is processed based on the result of the judgment. According to the present invention, the VMM intercepts the hard disk storage unit involved in the hard disk read-write command and returns to the operating system the information indicating inoperability or error data if the hard disk storage unit is the hard disk storage unit needed to be protected as instructed by the user. Therefore data is secured effectively to avoid infection from virus or attacks from hackers.

### BACKGROUND OF THE INVENTION

1. Field of Invention

The present invention relates to data protection, in particular to a method for protecting hard disk data in a virtual context.

2. Description of Prior Art

As shown in FIG. 1, so-called virtualization technology is embodied by inserting a VMM (Virtual Machine Monitor) between a physical hardware platform 1 and operating systems 3. The VMM is employed to simulate various hardware devices such that the operating systems 3 in respective virtual machines (VMs) act as communicating with the hardware by themselves, however, it is the VMM that actually takes charge of interruption and resource allocation. The VMM can intercept all accesses from the operating system to the hardware.

The virtualization technology can integrate a plurality of operating systems into one powerful machine, as shown in FIG. 1, to make maximum use of all resources of a hardware platform and to further implement more applications with less investment. In addition, a plurality of virtual machines executing the same application can be duplicated in a single server. In this way, when a problem in the program executed in some virtual machine occurs, another virtual machine can be used for substitution in a quick manner so as to maintain the continuity of a task to the highest extent without increasing excessive investment in the hardware platform.

Specifically, the VMM functions mainly in four aspects, including:

simulating a complete hardware environment such that any operating system or application has no idea as to whether it communicates with hardware actually or with a virtual machine;

isolating such that different virtual machines are located in different partitions and hence the error in one virtual machine won't impose any effect on another one;

allocating platform resource containing process, memory, I/O, storage and the like; and

encapsulating software stack containing operating system and status information such that they can be easily copied and transmitted to a new virtual machine.

At present, data stored in the computer is of great importance to most of enterprises and users, and thus a key issue appears as to how the data in a hard disk, especially important data, can be protect with the utilization of virtual mechanism.

Currently, the protection for hard disk in a virtual context is primarily realized by using an individual region to protect data, and it requires a particular application to handle the access to this individual region. With such individual data protecting region that cannot be accessed by the system, however, a user has to execute the particular application to move data to be protected to this protective region when he or she wants to protect the data. This causes inconvenience to the user.

### SUMMARY OF THE INVENTION

The object of the present invention is to provide a method for protecting hard disk data in a virtual context, which is simple to carry out and easy to operate so that a user can easily perform data protection and encryption and thus prevent data from being infected by any virus or attacked by any hacker.

In order to achieve the above object, the present invention provides a method for protecting hard disk data in a virtual context, wherein:

a virtual machine monitor acquires information on a hard disk storage unit needed to be protected as instructed by a user;

the virtual machine monitor acquires information on a hard disk storage unit to be accessed by a hard disk read-write command from operating system based on the read-write command;

the virtual machine monitor judges whether the hard disk storage unit to be accessed by the read-write command is the hard disk storage unit needed to be protected based on the information on the hard disk storage unit to be accessed by the read-write command as well as the information on the hard disk storage unit under protection as instructed by the user;

the hard disk read-write command is processed based on the result of the judgment.

In the above method for protecting hard disk data in a virtual context, the step of processing the hard disk read-write command based on the result of the judgment further comprises returning error data or information indicating non-operability to the operating system if the hard disk storage unit to be accessed by the read-write command is the hard disk storage unit needed to be protected, while reading or writing on the hard disk in a normal flow if the hard disk storage unit to be accessed by the read-write command is not the hard disk storage unit under protection.

In the above method for protecting hard disk data in a virtual context, the virtual machine monitor acquires the information on the hard disk storage unit needed to be protected as instructed by the user by sharing memory or intercepting read-write I/O port.

In the above method for protecting hard disk data in a virtual context, the hard disk storage unit is a hard disk sector, a hard disk cylinder and/or hard disk space with a hard disk label.

In the above method for protecting hard disk data in a virtual context, when the hard disk storage unit is a hard disk sector, the information on the hard disk storage unit is the sector number of the hard disk sector.

In the above method for protecting hard disk data in a virtual context, the sector number of the hard disk sector needed to be protected is saved in the virtual machine monitor or a shared memory.

In the above method for protecting hard disk data in a virtual context, if the hard disk sector needed to be protected comprises continuous blocks of sectors, the blocks of sectors whose sector numbers are continuous are saved as one part including the sector number of the initial sector and the quantity of the sectors in the continuous blocks.

In order to achieve the above object more advantageously, the present invention further provides a system for protecting hard disk data in a virtual context, which comprises:

a module for saving information on hard disk storage unit needed to be protected which saves information on a hard disk storage unit needed to be protected as instructed by a user;

hard disk read-write command acquiring and analyzing module which acquires a hard disk read-write command from operating system and, based on the read-write command, acquires information on a hard disk storage unit to be accessed by the hard disk read-write command;

a hard disk read-write command judging module which judges whether the hard disk storage unit to be accessed by the read-write command is the hard disk storage unit needed to be protected based on the information on the hard disk storage unit to be accessed by the read-write command as well as the information on the hard disk storage unit needed to be protected as instructed by the user;

a hard disk read-write command executing module which processes the hard disk read-write command based on the result of the judgment.

In the above system for protecting hard disk data in a virtual context, the hard disk read-write command executing module is specifically configured to return error data or information indicating non-operability to the operating system if the hard disk storage unit to be accessed by the read-write command is the hard disk storage unit needed to be protected, and perform read/write operation on the hard disk in a normal flow if the hard disk storage unit to be accessed by the read-write command is not the hard disk storage unit needed to be protected.

In the above system for protecting hard disk data in a virtual context, the hard disk storage unit is a hard disk sector, a hard disk cylinder and/or hard disk space with a hard disk label.

In the above system for protecting hard disk data in a virtual context, when the hard disk storage unit is a hard disk sector, the information on the hard disk storage unit is the sector number of the hard disk sector.

In the above system for protecting hard disk data in a virtual context, the module for saving information on hard disk storage unit needed to be protected is provided in the virtual machine monitor or a shared memory.

In the method and system for protecting hard disk data in a virtual context according to the present invention, the VMM intercepts the hard disk storage unit involved in the hard disk read-write command and returns to the operating system the information indicating non-operability or error data if the hard disk storage unit is the hard disk storage unit needed to be protected as instructed by the user. Therefore, data is secured effectively to avoid infection from virus or attacks from hackers.

### BRIEF DESCRIPTION OF THE DRAWINGS

FIG. 1 is a schematic diagram for the architecture of a computer system utilizing virtualization technology.

FIG. 2 is a schematic flowchart of the method for protecting hard disk data in a virtual context according to the present invention.

FIG. 3 is a schematic structural diagram of the system for protecting hard disk data in a virtual context according to the present invention.

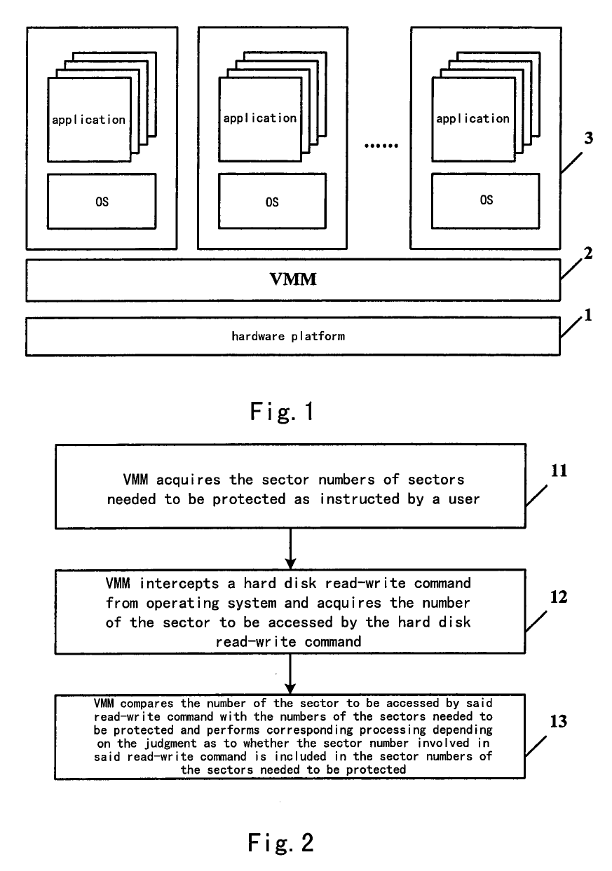

### DETAILED DESCRIPTION OF PREFERRED EMBODIMENTS

The method for protecting hard disk data in a virtual context according to the present invention protects the storage unit (e.g., sector, cylinder or even the entire hard disk space under some disk label) of a hard disk by means of a VMM. Specifically, it is judged whether the storage unit related to the hard disk access operation is a storage unit under protection after a hard disk access operation is intercepted by the VMM, and different processing methods are adopted based on the result of the above judgment, thereby effectively guaranteeing the security of hard disk data.

The protection method for hard disk storage unit, as mentioned in the present invention, comprises locking or locking plus encrypting the hard disk storage unit or other protection methods.

A detailed explanation is now given to the present invention by example of a hard disk sector that is the smallest storage unit in a hard disk.

As shown in FIG. 2, the method for protecting hard disk data in a virtual context according to the present invention mainly comprises the following steps.

In step 11, a VMM acquires the sector numbers of sectors needed to be protected as a user instructs.

In step 12, the VMM intercepts a hard disk read-write command from operating system and acquires the number of the sector to be accessed by the hard disk read-write command.

In step 13, the VMM compares the number of the sector to be accessed by said read-write command with the numbers of the sectors needed to be protected and performs corresponding processing depending on the judgment as to whether the sector number involved in said read-write command is included in the sector numbers of the sectors needed to be protected.

Further, a more detailed description will be made on the present invention.

The sector numbers of the sectors needed to be protected in the step 11 may be represented in various forms. For example, the sector numbers of the sectors needed to be protected can be saved in a sector access control list, or the blocks of sectors whose sector numbers are continuous in the sectors needed to be protected are saved as one part that includes the sector number of the initial sector and the amount of the sectors included in the continuous blocks.

Take an example of the following case, in which the sector numbers of the sectors needed to be protected is assumed as 10001˜50000, 70001˜80000 and 90001˜95000, the sector access control lists corresponding to the above two forms are shown as the two tables below, respectively.

| Order IDs | Sector Numbers |
|---|---|
| 1 | 10001 |
| 2 | 10002 |
| . . . | . . . |
| 40000 | 50000 |
| 40001 | 70001 |
| 40002 | 70002 |
| . . . | . . . |
| 50000 | 80000 |
| 50001 | 90001 |
| 50002 | 90002 |
| . . . | . . . |
| 55000 | 95000 |

| Order IDs | Initial Sector Number | Quantity of Continuous Sectors |
|---|---|---|
| 1 | 10001 | 40000 |
| 2 | 70001 | 10000 |
| 3 | 90001 | 5000 |

Next, the step 11 in the present invention will be elaborated, where the process of issuing the information on the sectors needed to be protected to the VMM via the operating system by the user can be realized by sharing memory or reading or writing I/O port.

### (1) Memory Sharing

The user invokes a command VMCALL via the operating system, transfers the pointer of the shared memory via EAX and the size of the shared memory via EBX.

The data in the shared memory contains the sector numbers of the sectors needed to be protected.

Of cause, if there are sectors needed to be protected whose sector numbers are continuous, the data in the shared memory can also contains the sector number of the initial sector and the quantity of the sectors in these continuous blocks of sectors needed to be protected.

The above data can further include content as to whether there is an encryption and what the encryption scheme is.

The VMM can acquire the sector numbers of the sectors needed to be protected from the shared memory to create the sector access control list. On the other hand, since the VMM may access to all memories, it doesn't have to acquire the data in the shared memory. In the step 3, the VMM compares the sector number of the sector to be access by the read-write command with the data in the shared memory and make relevant judgment directly after acquiring the sector number of the sector to be access by the read-write command.

### (2) Interception of Read-Write I/O

The information on the sectors needed to be protected can also be issued to the VMM by intercepting read-write I/O, which will be illustrated in two embodiments.

In the first embodiment, one command is issued via the port (IOBASE=1F0,170)+7 for sending a command to hard disk, the pointer to the shared memory is transferred via IOBASE+2, IOBASE+3, IOBASE+4 and IOBASE+5, and the size of the shared memory is transferred via IOBASE+2, IOBASE+3, IOBASE+4 and IOBASE+5 which have been written once more. The shared memory is the same as that mentioned in the above memory sharing scheme.

After acquiring the pointer to the shared memory and the size of the shared memory by intercepting hard disk read-write I/O, the VMM acquires the information on the sectors needed to be protected from the shared memory and further maintains the sector access control list based on the information on the sectors needed to be protected.

Since the VMM may access to all memories, it doesn't have to acquire the data in the shared memory. In step 3, the VMM compares the sector number of the sector to be access by the read-write command with the data in the shared memory and make a relevant judgment directly after acquiring the sector number of the sector to be access by the read-write command.

In the second embodiment, one command is issued via the port (IOBASE=1F0,170)+7 for sending a command to hard disk, and the sector numbers of the sectors needed to be protected are sent via IOBASE+3, IOBASE+4 and IOBASE+5. Meanwhile, the VMM intercepts the command, acquires the sector numbers of the sectors needed to be protected included in the command and further maintains the sector access control list.

In the above second embodiment, if there are sectors needed to be protected whose sector numbers are continuous, the relevant flow can be carried out in such manner as follows.

One command is issued via the port (IOBASE=1F0,170)+7 for sending a command to hard disk, and the sector number of the initial sector in the continuous blocks of the sectors needed to be protected is sent via IOBASE+3, IOBASE+4 and IOBASE+5. Meanwhile, with another command, the quantity of the sectors in the continuous blocks of the sectors needed to be protected is sent via IOBASE+3, IOBASE+4 and IOBASE+5. The VMM intercepts the commands, acquires the information on the sectors needed to be protected and further maintains the sector access control list.

In step 12, the VMM needs to intercept the read-write command for hard disk I/O from the operating system so as to acquire the hard disk sector involved in the read-write command. Below is a detailed illustration for this step.

Since there exist various commands for hard disk access, and these commands have substantially the same mode, the present invention will be described by example of a PIO-mode (Programmed I/O) reading command for hard disk.

The VMM intercepts the command for hard disk IO from the operating system via IOBASE+0X7 and judges whether the command is 0×20 (PIO read). If the answer is yes, the VMM acquires the sector quantity involved in the command for hard disk IO via IOBASE+0X2 and the associated sector number of hard disk sector by intercepting data IOBASE+0X6, IOBASE+0X5, IOBASE+0X4 and IOBASE+0X3.

Hereafter, the present invention will be explained in detail in conjunction with two cases of reading and writing.

In step 12, a VMEXIT is generated at the time of accessing IO space of an IDE (Integrated Driver Equipment) controller, and the VMM obtains the right to control and further acquires the sector number involve in the read-write command in the manner as described above.

If the sector number of hard disk sector involved in the hard disk read-write command from the operating system is included in the sector access control list or in the sectors needed to be protected saved in the shared memory, it is indicated that the hard disk sectors involve in the read-write command are sector needed to be protected as desired by the user, and the VMM returns information indicating non-operability or an error result, for example, the result is only 0. If the sector number of hard disk sector involved in the hard disk read-write command from the operating system is not included in the sector access control list, it is indicated that the hard disk sector involve in the read-write command is a general hard disk sector, and thus the VMM reads or writes on the hard disk sector by use of normal read-write program and returns the result of the operation to the user.

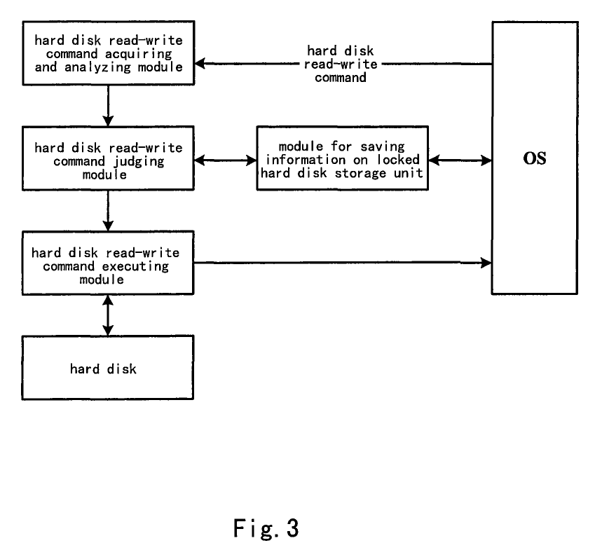

Furthermore, the present invention also proposes a system for protecting hard disk data in a virtual context, which is provided in the VMM and, as shown in FIG. 3, comprises: a module for saving information on hard disk storage unit needed to be protected which saves information on a hard disk storage unit needed to be protected as instructed by a user, and the information can be, for example, the sector numbers of the sectors needed to be protected, the cylinder numbers of the cylinders needed to be protected or the disk label of the hard disk needed to be protected;

a hard disk read-write command acquiring and analyzing module which intercepts a hard disk read-write command from operating system and acquires information on a hard disk storage unit to be accessed by the hard disk read-write command;

a hard disk read-write command judging module which judges whether the hard disk storage unit to be accessed by the read-write command is the hard disk storage unit needed to be protected based on the information on the hard disk storage unit to be accessed by the read-write command as well as the information on the hard disk storage unit needed to be protected; and

hard disk read-write command executing module which returns error data or information indicating non-operability to the operating system if the hard disk storage unit to be accessed by the read-write command is the hard disk storage unit needed to be protected, and reads or writes on the hard disk in a normal flow if the hard disk storage unit to be accessed by the read-write command is not the hard disk storage unit needed to be protected.

The above describes only the preferred embodiments of the invention. It will be appreciated for those skilled in the art that various modification and refinement can be made in the principle of the present invention, and these modification and refinement should fall into the scope of the present invention.

1. A method for protecting hard disk data in a virtual context, wherein a virtual machine monitor acquires information on a hard disk storage unit needed to be protected as instructed by a user;
the virtual machine monitor acquires information on a hard disk storage unit to be accessed by a hard disk read-write command from operating system based on the read-write command;
the virtual machine monitor judges whether the hard disk storage unit to be accessed by the read-write command is the hard disk storage unit needed to be protected based on the information on the hard disk storage unit to be accessed by the read-write command as well as the information on the hard disk storage unit needed to be protected as instructed by the user; and
the hard disk read-write command is processed based on the result of the judgment.

2. The method for protecting hard disk data in a virtual context according to claim 1, wherein the step of processing the hard disk read-write command based on the result of the judgment further comprises:
returning error data or information indicating non-operability to the operating system if the hard disk storage unit to be accessed by the read-write command is the hard disk storage unit under protection, and reading or writing on the hard disk in a normal flow if the hard disk storage unit to be accessed by the read-write command is not the hard disk storage unit under protection.

3. The method for protecting hard disk data in a virtual context according to claim 1, wherein the virtual machine monitor acquires the information on the hard disk storage unit needed to be protected as instructed by the user by sharing memory or intercepting read-write I/O port.

4. The method for protecting hard disk data in a virtual context according to claim 1, wherein the hard disk storage unit is a hard disk sector, a hard disk cylinder and/or hard disk space with a hard disk label.

5. The method for protecting hard disk data in a virtual context according to claim 4, wherein when the hard disk storage unit is a hard disk sector, the information on the hard disk storage unit is the sector number of the hard disk sector.

6. The method for protecting hard disk data in a virtual context according to claim 5, wherein the sector number of the hard disk sector needed to be protected is saved in the virtual machine monitor or a shared memory.

7. The method for protecting hard disk data in a virtual context according to claim 6, wherein if the hard disk sector needed to be protected comprises continuous blocks of sectors, the blocks of sectors whose sector numbers are continuous are saved as one part including the sector number of the initial sector and the quantity of the sectors in the continuous blocks.

8. A system for protecting hard disk data in a virtual context, which comprises:
a module for saving information on hard disk storage unit needed to be protected which saves information on a hard disk storage unit needed to be protected as instructed by a user;
a hard disk read-write command acquiring and analyzing module which is provided in the virtual machine monitor acquires a hard disk read-write command from operating system and, based on the read-write command, acquires information on a hard disk storage unit to be accessed by the hard disk read-write command;
a hard disk read-write command judging module which judges whether the hard disk storage unit to be accessed by the read-write command is the hard disk storage unit needed to be protected based on the information on the hard disk storage unit to be accessed by the read-write command as well as the information on the hard disk storage unit needed to be protected as instructed by the user; and
a hard disk read-write command executing module which is provided in the virtual machine monitor processes the hard disk read-write command based on the result of the judgment.

9. The system for protecting hard disk data in a virtual context according to claim 8, wherein the hard disk read-write command executing module is configured to return error data or information indicating non-operability to the operating system if the hard disk storage unit to be accessed by the read-write command is the hard disk storage unit needed to be protected, and perform read/write operation on the hard disk in a normal flow if the hard disk storage unit to be accessed by the read-write command is not the hard disk storage unit needed to be protected.

10. The system for protecting hard disk data in a virtual context according to claim 8, wherein the hard disk storage unit is a hard disk sector, a hard disk cylinder and/or hard disk space with a hard disk label.

11. The system for protecting hard disk data in a virtual context according to claim 8, wherein when the hard disk storage unit is a hard disk sector, the information on the hard disk storage unit is the sector number of the hard disk sector.

12. The system for protecting hard disk data in a virtual context according to claim 8, wherein the module for saving information on hard disk storage unit needed to be protected is provided in the virtual machine monitor or a shared memory.

13. The method for protecting hard disk data in a virtual context according to claim 2, wherein the hard disk storage unit is a hard disk sector, a hard disk cylinder and/or hard disk space with a hard disk label.

14. The method for protecting hard disk data in a virtual context according to claim 3, wherein the hard disk storage unit is a hard disk sector, a hard disk cylinder and/or hard disk space with a hard disk label.
